(19) United States
(12) Patent Application Publication
(10) Pub. No.: US 2012/0161916 A1
(43) Pub. Date: Jun. 28, 2012

(54) CORE UNIT AND INDUCTOR HAVING THE CORE UNIT

(75) Inventors: Wing-Keung ENG, TAIPEI (TW); Ming-Yang TSAI, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/162,800

(22) Filed: Jun. 17, 2011

(30) Foreign Application Priority Data
Dec. 22, 2010 (CN) 201010620544.X

(51) Int. Cl. H01F 27/24

(52) U.S. Cl. 336/212

(57) ABSTRACT

A core unit includes first and second core elements. The first core element includes a first peripheral portion and a first leakage inductance portion that is confined by the first peripheral portion and that has a first end surface. The second core element includes a second peripheral portion and a second leakage inductance portion that is confined by the second peripheral portion and that has a second end surface. The first and second peripheral portions are connected to each other, and the first and second end surfaces are disposed to face each other and are spaced apart from each other so as to form a gap therebetween. At least one of the first and second end surfaces is a non-level surface.

### CROSS-REFERENCE TO RELATED APPLICATION

This application claims priority of Chinese application No. 201010620544.X, filed on Dec. 22, 2010.

### BACKGROUND OF THE INVENTION

1. Field of the Invention

This invention relates to a core unit, more particularly to a core unit of an inductor that has a configurable inductance.

2. Description of the Related Art

As shown in FIG. 1, a core unit of a conventional inductor found in a power supply includes a first core element 1 and a second core element 2. The first core element 1 has a first peripheral portion 11 and a first leakage inductance portion 12 that is confined by the first peripheral portion 11 and that has a first end surface 13. The second core element 2 includes a second peripheral portion 21 and a second leakage inductance portion 22 that is confined by the second peripheral portion 21 and that has a second end surface 23. The first and second peripheral portions 11, 21 are connected to and face each other, and the first and second end surfaces 13, 23 are disposed to face each other and are spaced apart from each other so as to form a gap 20 therebetween. A coil (not shown) surrounds the first and second leakage inductance portions 12, 22 so as to form the conventional inductor.

However, the first and second end surfaces 13, 23 are level surfaces parallel to each other, and the gap 20 therebetween has a uniform width dimension, such that an inductance of the conventional inductor is fixed. Consequently, when the input current is relatively small, it is not possible to increase the inductance. If the input current is increased to increase the inductance, the conventional inductor has a tendency toward magnetic saturation, thereby failing to increase efficiency of a power supply adopting the conventional inductor by increase of input current.

### SUMMARY OF THE INVENTION

Therefore, one object of the present invention is to provide a core unit having an inductance that varies in accordance with an input current and that is capable of operating in a relatively wide range of input current. Another object of the present invention is to provide an inductor having the core unit.

According to one aspect of the present invention, there is provided a core unit comprising:

a first core element including a first peripheral portion and a first leakage inductance portion that is confined by the first peripheral portion and that has a first end surface; and

a second core element including a second peripheral portion and a second leakage inductance portion that is confined by the second peripheral portion and that has a second end surface;

wherein the first and second peripheral portions are connected to each other, and the first and second end surfaces are disposed to face each other and are spaced apart from each other so as to form a gap therebetween; and

wherein at least one of the first and second end surfaces is a non-level surface.

Preferably, one of the first and second end surfaces is configured as one of a stepped surface, a convex surface, a concave surface, an inclined surface, a recessed surface, a stepped convex surface, and a stepped concave surface.

Preferably, the gap has at least one large gap portion and at least one small gap portion smaller than said large gap portion.

Preferably, the gap is a nonlinear gap.

According to another aspect of the present invention, there is provided an inductor comprising:

a first core element including a first peripheral portion and a first leakage inductance portion that is confined by the first peripheral portion and that has a first end surface;

a second core element including a second peripheral portion and a second leakage inductance portion that is confined by the second peripheral portion and that has a second end surface;

the first and second peripheral portions being connected to each other, and the first and second end surfaces being disposed to face each other and being spaced apart from each other so as to form a gap therebetween;

at least one of the first and second end surfaces being a non-level surface; and

a coil surrounding the first and second leakage inductance portions.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic side view of a conventional core unit;

FIG. 2 is a schematic perspective view of a first core element of a core unit of a first preferred embodiment according to the present invention;

FIG. 3 is a schematic perspective view of a second core element of the core unit of the first preferred embodiment;

FIG. 4 is an assembled schematic side view of the core unit of the first preferred embodiment;

FIG. 5 is an exploded perspective view of the first preferred embodiment and a coil wound on a spool, illustrating how the spool is assembled with the core unit to form an inductor;

FIG. 6 is for illustrating B-H curves of both the core unit of the first preferred embodiment according to the present invention and another core unit of a conventional inductor during operation thereof;

FIG. 7 is a schematic perspective view of a second core element of the core unit of a second preferred embodiment according to the present invention;

FIG. 8 is an assembled schematic side view of the core unit of the second preferred embodiment; and

FIGS. 9 to 14 illustrate modifications of a first end surface of the first core element or a second end surface of the second core element of the core unit according to the present invention.

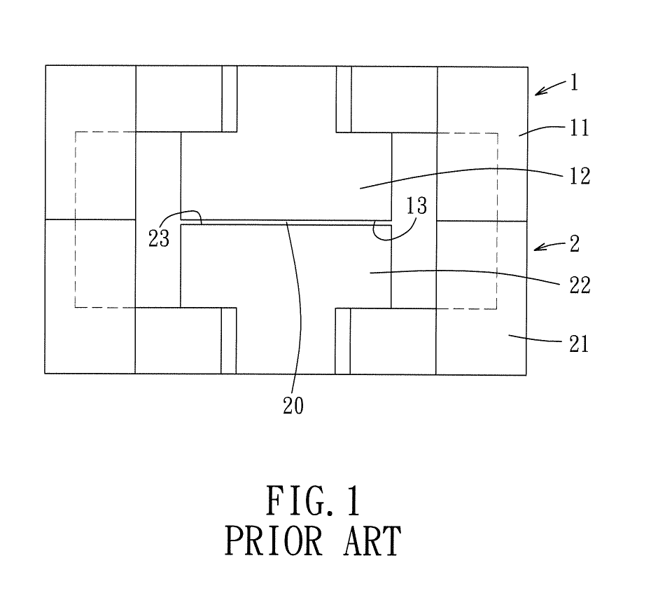

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

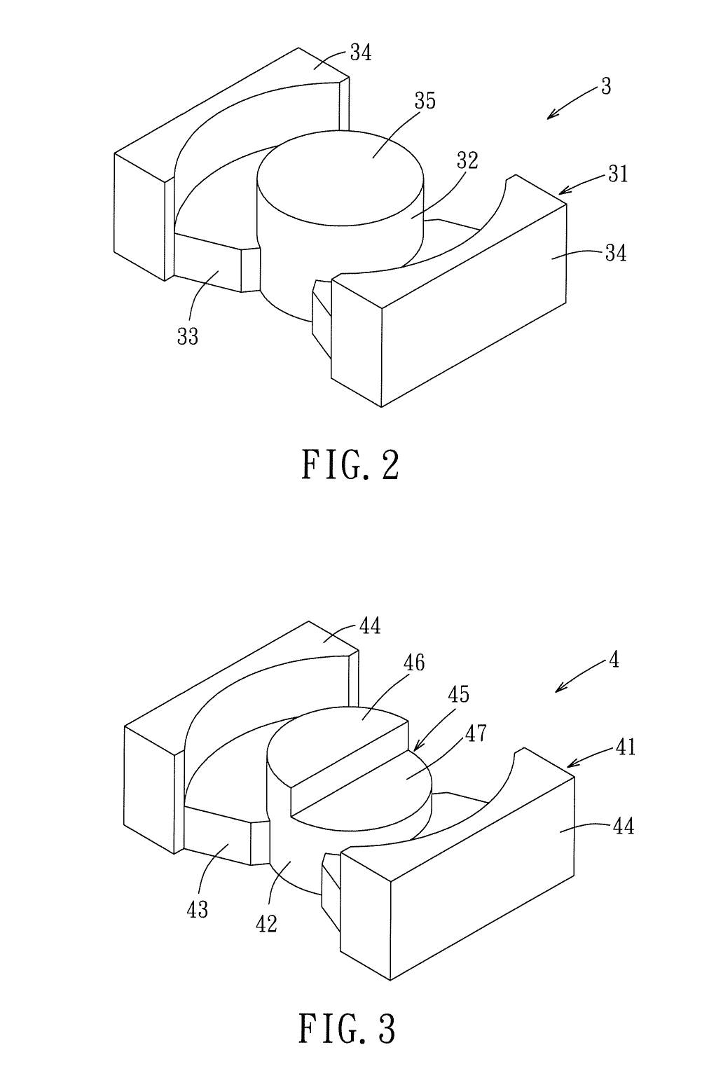

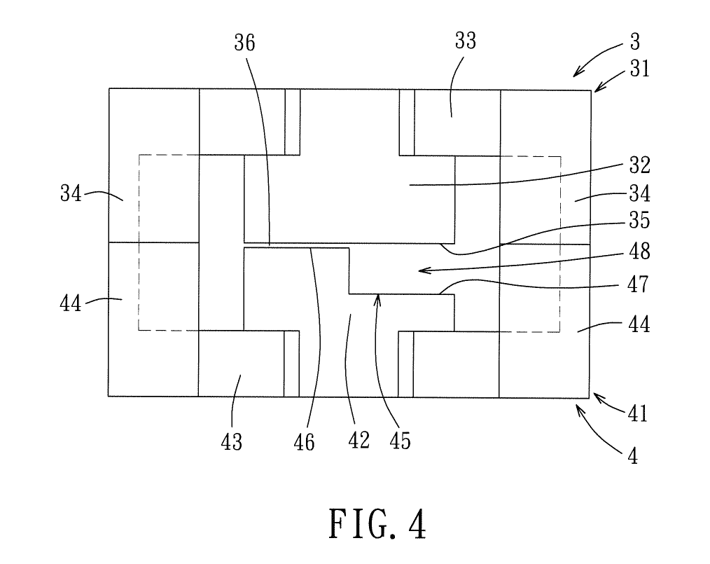

Referring to FIGS. 2 to 4, a core unit mainly applicable to an inductor of a first preferred embodiment according to the present invention is shown to include a first core element 3 and a second core element 4.

The first core element 3 includes a first peripheral portion 31 and a substantially cylindrical first leakage inductance portion 32. The first peripheral portion 31 has a horizontal plate 33 and two lateral walls 34 flanking the plate 33 and extending perpendicularly and respectively therefrom. The first leakage inductance portion 32 is confined by the first peripheral portion 31, extends from the plate 33 in a direction parallel to the lateral walls 34, and has a substantially horizontal (or level) first end surface 35.

The second core element 4 includes a second peripheral portion 41 and a substantially cylindrical second leakage inductance portion 42. The second peripheral portion 41 has a horizontal plate 43 and two lateral walls 44 flanking the plate 43 and extending perpendicularly and respectively therefrom. The second leakage inductance portion 42 is confined by the second peripheral portion 41, extends from the plate 43 in a direction parallel to the lateral walls 44, and has a non-level second end surface 45 having a first segment 46 and a second segment 47 located lower than the first segment 46.

The first and second peripheral portions 31, 41 are connected to and face each other. The first and second end surfaces 35, 45 are disposed to face each other and are spaced apart from each other so as to form a nonlinear gap that has a first gap portion 36 and a second gap portion 48 larger than the first gap portion 36 therebetween. The first gap portion 36 is formed between the first end surface 35 and the first segment 46 of the second end surface 45, and the second gap portion 48 is formed between the first end surface 35 and the second segment 47 of the second end surface 45.

In this embodiment, the first and second core elements 3, 4 are formed separately and individually. It should be noted that the first and second core elements 3, 4 may also be formed integrally with each other, and the first and second peripheral portions 31, 41 may be connected integrally to each other in other embodiments of this invention.

As shown in FIG. 5, in order to form an inductor, a spool 62 is provided to sleeve on the first and second leakage inductance portions 32, 42, and a coil 61 is wound on the spool 62 so as to surround the first and second leakage inductance portions 32, 42.

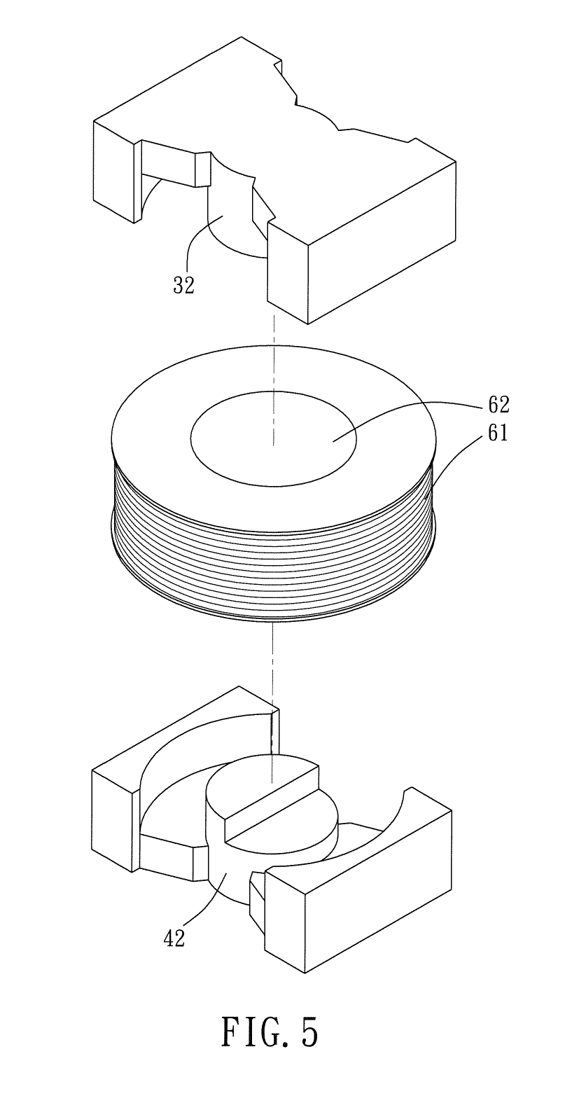

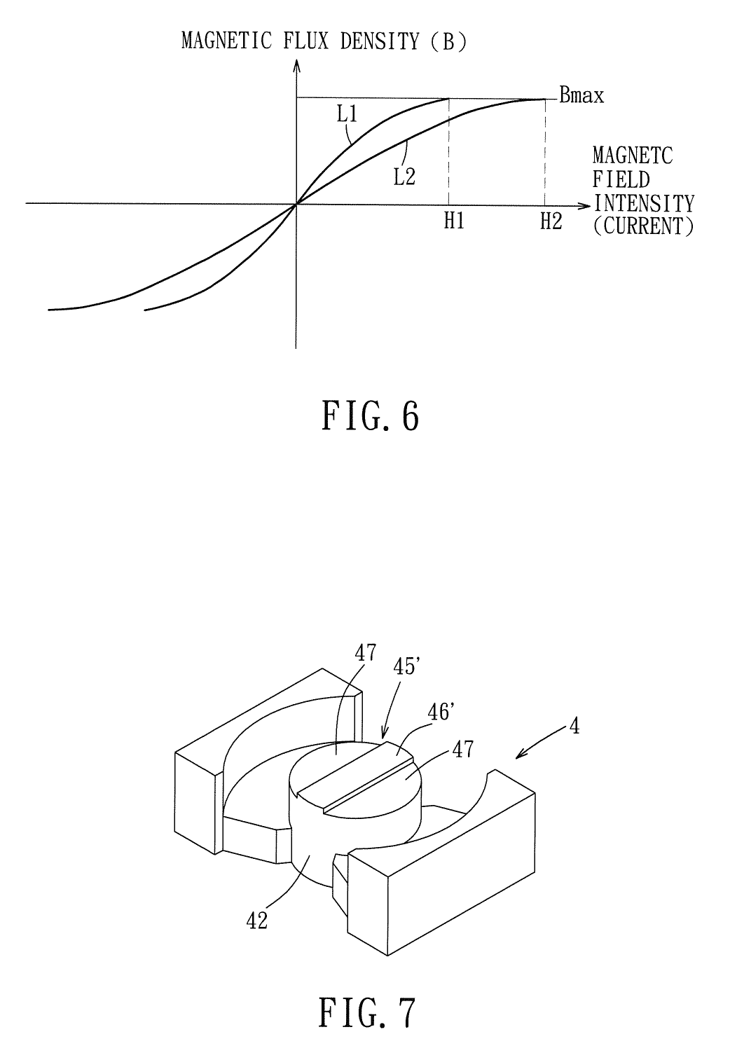

Referring to FIG. 6, B-H curves (L1, L2) are shown to respectively illustrate variation of magnetic flux density of a core unit of a conventional inductor and the core unit of the inductor of the present invention in accordance with change in input current, i.e., change in magnetic field intensity. As shown by the curves (L1, L2), when the input current is increased, the magnetic flux density (B) is increased as well.

It should be noted that the first gap portion 36 and a gap of the core unit of the conventional inductor have identical width dimension. The curve (L1) indicates that the conventional inductor saturates at a maximum value (Bmax) when the input current is increased to the first threshold value (H1). In the contrary, the curve (L2) indicates that when an input current flowing through the coil 61 is relatively small, a magnetic flux of the inductor passes through the first gap portion 36 which incurs a relatively small magnetic reluctance, such that a relatively high inductance can be obtained. Once the input current is increased to a first threshold value (H1), the magnetic flux passes through the second gap portion 48 which incurs a relatively large reluctance to obtain a relatively low inductance.

Consequently, the inductor having the core unit of the present invention can operate in a wider range of input current until the input current increased to a second threshold value (H2), which results in occurrence of magnetic saturation of the inductor at the second gap portion 48.

Therefore, when the inductor is applied to a circuit utilizing a power factor correction boost converter at a power supply, output power efficiency of the circuit can be improved.

For a circuit employing a linear gap inductor, it is difficult to increase efficiency of the circuit without increase of cost and modification of circuit design. According to Table 1 below, for example, when a circuit having a 460 W power supply and using 230Vac as input voltage, output power efficiency of the circuit that has an output power equal to 230 W is merely increased 0.3%˜0.5% to achieve 94.18% after increasing cost of the circuit and adopting additional solutions.

On the other hand, when the inductor having the core unit of the first preferred embodiment that has a nonlinear gap is applied to the 460 W power supply, the output power efficiency of the circuit having 230 W output power can be increased to 94.51% without the above-mentioned additional increase of cost and modification of circuit design. In this embodiment, the first gap portion 36 has a width dimension of 1 mm and the second gap portion 48 has a width dimension of 3.5 mm. Additionally, the output power efficiency of the circuit that employs the 460 W power supply and that has an output power equal to 92 W (20%) or 46 W (10%) is also improved evidently.

Similarly, for a circuit having a 460 W power supply that utilizes the core unit of the first preferred embodiment and employing 115Vac as input voltage, output power efficiency of the circuit that has an output power equal to 230 W (50%), 92 W (20%), or 46 W (10%) is improved significantly as well.

It should be noted that, in this case, when the output power is equal to 460 W, the output power efficiency is lower than that of the circuit that employs the linear gap inductor as a result of design for the circuit that has a fifty percent output power of 230 W. Nevertheless, the circuit having the core unit of the first preferred embodiment can still operate in a wider range of input current. For instance, for the circuit having an output power of 230 W (500), a 92.75% output power efficiency can be obtained. Further, occurrence of magnetic saturation of the inductor can be avoided as the output power equal to 460 W (1000).

In contrast thereto, the output power efficiency of the circuit employing the linear gap inductor and having an output power of 230 W (50%) is only 92.45%. If it is desired to increase the output power efficiency thereof, the circuit would reach magnetic saturation as the output power equal to 460 W (100%).

TABLE 1

| | | Output Power | Output Power |
|---|---|---|---|
| | | Efficiency of a | Efficiency of a |
| | | circuit adopting | circuit adopting |
| | | an inductor | an inductor |
| Input | Output | having a linear | having a |
| Voltage | Power | gap (%) | nonlinear gap (%) |
| 230 Vac | 460 W | 93.72 | 93.77 |
| | 230 W | 94.18 | 94.51 |
| | 92 W | 91.27 | 91.65 |
| | 46 W | 85.98 | 86.72 |
| 115 Vac | 460 W | 90.83 | 90.34 |
| | 230 W | 92.45 | 92.75 |
| | 92 W | 89.98 | 90.46 |
| | 46 W | 84.92 | 86.58 |

According to Table 2 below, for a circuit utilizing a power factor correction boost converter, having a 300 W power supply, and using 100Vac as input voltage, when employing the inductor of the first preferred embodiment, in which the first gap portion 36 has a width dimension of 1 mm and the second gap portion 48 has a width dimension of 3 mm, output power efficiency of the circuit having output power equal to 300 W, 150 W, or 60 W is better than another circuit that employs a conventional inductor having a linear gap.

TABLE 2

| | | Output Power | Output Power |
|---|---|---|---|
| | | Efficiency of a | Efficiency of a |
| | | circuit adopting | circuit adopting |
| | | an inductor | an inductor |
| Input | Output | having a linear | having a |
| Voltage | Power | gap (%) | nonlinear gap (%) |
| 110 Vac | 300 W | 93.88 | 94.15 |
| | 150 W | 94.18 | 95.88 |
| | 60 W | 95.29 | 95.54 |

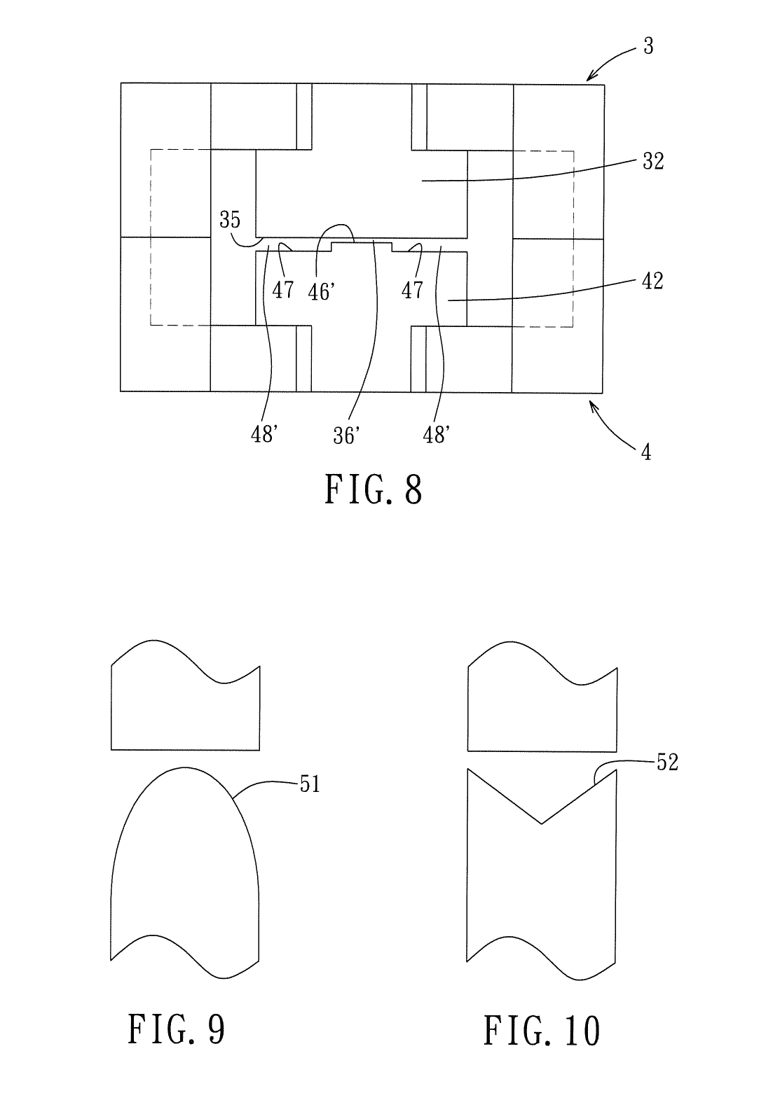

Referring to FIGS. 7 and 8, a second preferred embodiment of a core unit of the present invention is shown. The main difference between the second embodiment and the first embodiment resides in the configuration of the second end surface 45′ of the second leakage inductance portion 42 of the second core element 4. The second end surface 45′ has two second segments 47 and a first segment 46′ disposed between the second segments 47. The first gap portion 36′ is formed between the first segment 46′ and the first end surface 35 of the first leakage inductance portion 32 of the first core element 3, and two second gap portions 48′ are formed between the second segments 47 and the first end surface 35, respectively.

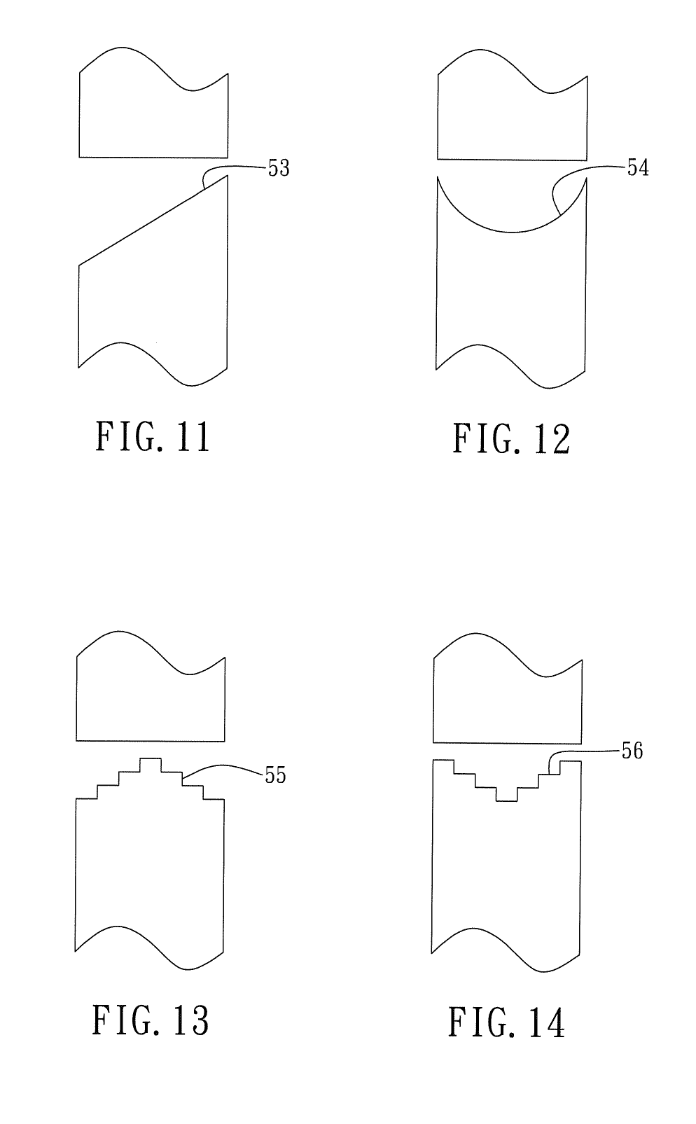

Referring to FIGS. 9 to 14, the second end surface 45 may be configured as one of a stepped surface, a convex surface 51, a concave surface 54, an inclined surface 53, a recessed surface 52, a stepped convex surface 55, and a stepped concave surface 56.

Therefore, the configuration of at least one of the first and second end surfaces 35, 45 of the first and second leakage inductance portions 32, 42 can be designed according to the output power efficiency and the output power of the circuit that employs the inductor as desired, in which the nonlinear gap between the first and second end surfaces 35, 45 and sectional area of the first and second segments of one of the first and second end surface 35, 45 are taken under consideration to provide an optimized B-H curve for the inductor having the core unit of the present invention so as to achieve an optimized balance for a desirable output power efficiency of the circuit without magnetic saturation of the inductor.

It should be noted that the configuration of the nonlinear gap of the present invention may be applied to core units made of various materials and having different configurations. For example, the core unit can be made of ceramic, ferrite, and other materials, and the configuration of the core unit can be one of EE core, EER core, EPC core, EP core, PQ core, LP core, QP core, CC core, ATP core, and EI core. Furthermore, the invention may also be applied to a buck converter or a buck-boost converter, and a power supply of an adapter, a server, or a work station etc., and other products of power electronics.

To sum up, at least one of the first and second end surfaces 35, 45 of the first and second leakage inductance portions 32, 42 of the present invention is a non-level surface, such that the gap formed therebetween is a nonlinear (non-paralleled) gap. The inductor has a configurable inductance that varies in accordance with the input current, in which magnetic flux of the core unit of the inductor passes through a suitable gap portion of the nonlinear gap, thus allowing the inductor to operate in a wider range of input current and provide a variable inductance prior to occurrence of magnetic saturation of the inductor.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A core unit comprising:
a first core element including a first peripheral portion and a first leakage inductance portion that is confined by said first peripheral portion and that has a first end surface; and
a second core element including a second peripheral portion and a second leakage inductance portion that is confined by said second peripheral portion and that has a second end surface;
wherein said first and second peripheral portions are connected to each other, and said first and second end surfaces are disposed to face each other and are spaced apart from each other so as to form a gap therebetween; and
wherein at least one of said first and second end surfaces is a non-level surface.

2. The core unit as claimed in claim 1, wherein at least one of said first and second end surfaces is configured as one of a stepped surface, a convex surface, a concave surface, an inclined surface, a recessed surface, a stepped convex surface, and a stepped concave surface.

3. The core unit as claimed in claim 1, wherein said first and second core elements are formed separately and individually, and said first and second peripheral portions face each other.

4. The core unit as claimed in claim 1, wherein said first and second core elements are formed integrally with each other, and said first and second peripheral portions are connected integrally to and face each other.

5. The core unit as claimed in claim 1, wherein said gap has at least one large gap portion and at least one small gap portion smaller than said large gap portion.

6. The core unit as claimed in claim 1, wherein said gap is a nonlinear gap.

7. An inductor comprising:
a first core element including a first peripheral portion and a first leakage inductance portion that is confined by said first peripheral portion and that has a first end surface;
a second core element including a second peripheral portion and a second leakage inductance portion that is confined by said second peripheral portion and that has a second end surface;
said first and second peripheral portions being connected to each other, and said first and second end surfaces being disposed to face each other and being spaced apart from each other so as to form a gap therebetween;
at least one of said first and second end surfaces being a non-level surface; and
a coil surrounding said first and second leakage inductance portions.

8. The inductor as claimed in claim 7, wherein at least one of said first and second end surfaces is configured as one of a stepped surface, a convex surface, a concave surface, an inclined surface, a recessed surface, a stepped convex surface, and a stepped concave surface.

9. The inductor as claimed in claim 7, wherein said first and second core elements are formed separately and individually, and said first and second peripheral portions face each other.

10. The inductor as claimed in claim 7, wherein said first and second core elements are formed integrally with each other, and said first and second peripheral portions are connected integrally to and face each other.

11. The inductor as claimed in claim 7, wherein said gap has at least one large gap portion and at least one small gap portion smaller than said large gap portion.

12. The inductor as claimed in claim 7, wherein said gap is a nonlinear gap.

13. The inductor as claimed in claim 7, further comprising a spool sleeved on said first and second leakage inductance portions, said coil being wound on said spool.
